(19) United States
(12) Patent Application Publication
(10) Pub. No.: US 2024/0360990 A1
(43) Pub. Date: Oct. 31, 2024

(54) SWITCH TOGGLE STRUCTURE

(71) Applicant: Xiamen Topstar Lighting Co., Ltd., Xiamen (CN)

(72) Inventors: Xiaoyan ZHONG, Xiamen (CN); Yongjie WU, Xiamen (CN)

(73) Assignee: Xiamen Topstar Lighting Co., Ltd., Xiamen (CN)

(21) Appl. No.: 18/770,964

(22) Filed: Jul. 12, 2024

(30) Foreign Application Priority Data
Jul. 2, 2024 (CN) 202421542283.8

(51) Int. Cl. F21V 23/04; H01H 19/03; H01H 19/14

(52) U.S. Cl. CPC F21V 23/04; H01H 19/03; H01H 19/14

(57) ABSTRACT

A novel switch toggle structure includes an adjusting member and a driving switch. The lamp includes a housing and a lens. A front end of the housing is provided with a first opening, and the lens is provided on the opening; the lens includes an optical surface portion and a non-optical surface portion. The non-optical surface portion is provided with a second opening, an adjusting member is movably provided on the second opening, and a lower end of the adjusting member passes through the second opening and is in transmission connection with a driving switch located inside the housing; The assembled adjusting member can operate the driving switch inside the housing via the second opening; in addition, switching adjustment can be performed at the lens while ensuring that the lens normally emits light by designing the optical and non-optical surface portion of the lens.

### CROSS-REFERENCE TO RELATED APPLICATIONS

This application claims priority to Chinese Patent Application No. 202421542283.8, filed on Jul. 2, 2024, the content of which is incorporated herein by reference in its entirety.

### TECHNICAL FIELD

The present application relates to the field of lamp devices, and more particularly to a novel switch toggle structure.

### BACKGROUND

The current Light-Emitting Diode (LED) intelligence is a trend, one of which is to adjust the function of the product by toggling the exposed mechanical switch. The traditional LED products with PC housing are all to set the mechanism of adjusting switch on the injection molded PC housing, because the injection molded PC housing is easy to make opening or other structure to place the mechanism of adjusting switch. However, if the product is glass housing or other material housing which is not suitable for opening and structure, there is no good solution on the market to place the mechanism of adjusting switch.

### SUMMARY

The technical problem to be solved by the present application is to provide a novel switch toggle structure of a lamp which can be used for a material housing which is not suitable for being used as a structure, such as a glass housing.

In order to solve the above-mentioned technical problem, the technical solution adopted by the present application is: a novel switch toggle structure provided on a lamp, including an adjusting member and a driving switch; wherein the lamp includes a housing and a lens, wherein a front end of the housing is provided with a first opening, and the lens is provided on a first opening; the lens includes an optical surface portion and a non-optical surface portion, wherein the optical surface portion is used for transmitting light, a second opening is provided on the non-optical surface portion, the adjusting member is movably provided on the second opening, and a lower end of the adjusting member passes through the second opening and is in transmission connection with a driving switch located inside the housing.

Further, the non-optical surface portion is provided with a guide groove, and the adjusting member is movably engaged with the guide groove.

Further, the non-optical surface portion surrounds an optical surface portion; a ring of annular guide grooves is provided on the non-optical surface portion; the second opening is provided in the annular guide groove.

Further, the adjusting member is an annular member matched with the annular guide groove.

Further, the adjusting member is provided with anti-skid ribs.

Further, a limit hook is further included, wherein a lower side of the adjusting member is connected to the limit hook, the limit hook passes through the second opening and is clamped with a lower edge of the second opening.

Further, an upper side of the adjusting member projects a limit edge that abuts an upper edge of the second opening.

Further, a side of the non-optical surface portion facing the first opening is provided with a scale structure.

Further, a toggle member connected to a lower end of the adjusting member is further included, wherein the toggle member is in transmission connection with the driving switch through the second opening; an end portion of the toggle member is provided with a toggle notch, and two sides of the toggle notch are provided with guide inclined surfaces; the driving switch is provided with a switch toggle handle, and the toggle notch is engaged with the switch toggle handle.

The beneficial effects of the present application are as follows: for some occasions where the lamp housing is not easy to be re-processed, such as the housing made of glass and ceramic, by arranging the switch adjusting structure at the lens, a second opening can be opened synchronously when the lens is processed, so that the assembled adjusting member can operate the driving switch inside the housing via the second opening; in addition, by designing the optical surface portion and the non-optical surface portion of the lens to distinguish the light transmission structure from the non-optical surface portion of the corresponding adjusting member, switching adjustment can be performed at the lens while ensuring that the lens normally emits light.

### BRIEF DESCRIPTION OF THE DRAWINGS

FIG. 1 is a structure schematic view of a novel switch toggle structure according to the present embodiments.

FIG. 2 is a structure schematic view of an adjusting member of the novel switch toggle structure according to the present embodiments when being engaged with a driving switch.

FIG. 3 is a structure schematic view of lens of the novel switch toggle structure according to the present embodiments.

FIG. 4 is a structure schematic view of another view of the lens of the novel switch toggle structure according to the present embodiments.

FIG. 5 is a structure schematic view of an adjusting member of the novel switch toggle structure according to the present embodiments.

### DETAILED DESCRIPTION OF THE EMBODIMENTS

In order to explain the technical contents, the objects, and the effects of the present application in detail, the embodiments will be described below with reference to the accompanying drawings.

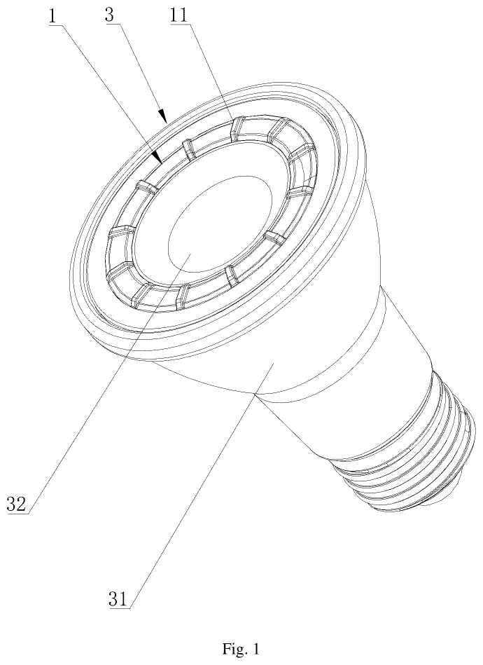

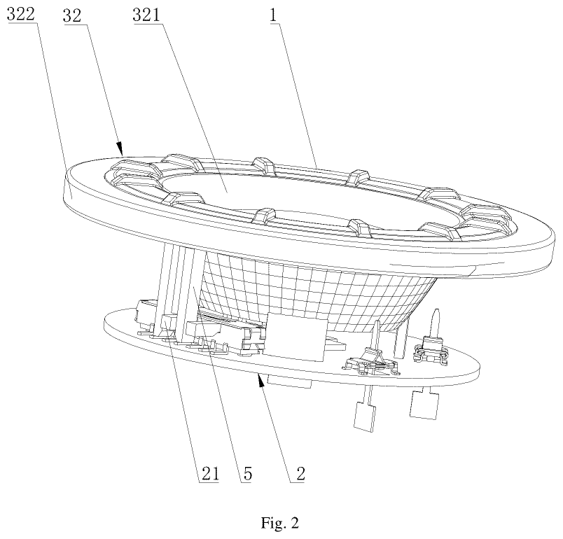

With reference to FIGS. 1 to 5, a novel switch toggle structure is provided on a lamp 3, including an adjusting member 1 and a driving switch 2; wherein the lamp 3 includes a housing 31 and a lens 32, wherein a front end of the housing 31 is provided with a first opening, and the lens 32 is provided on the first opening; the lens 32 includes an optical surface portion 321 and a non-optical surface portion 322, wherein the optical surface portion 321 is used for transmitting light, a second opening 323 is provided on the non-optical surface portion 322, the adjusting member 1 is movably provided on the second opening 323, and a lower end of the adjusting member 1 passes through the second opening 323 and is in transmission connection with a driving switch 2 located inside the housing 31.

It can be seen from the above description that the beneficial effects of the present application are as follows: for some occasions where the housing 31 of the lamp 3 is not easy to be re-processed, such as the housing 31 made of glass and ceramic, by arranging the switch adjusting structure at the lens 32, a second opening 323 can be opened synchronously when the lens 32 is processed, so that the assembled adjusting member I can operate the driving switch 2 inside the outer housing 31 via the second opening 323; in addition, by designing the optical surface portion 321 and the non-optical surface portion 322 of the lens 32 to distinguish the light transmission structure from the non-optical surface portion 322 of the corresponding adjusting member 1, switching regulation can be performed at the lens 32 while ensuring that the lens 32 normally emits light.

Further, the non-optical surface portion 322 is provided with a guide groove 324, and the adjusting member 1 is movably engaged with the guide groove 324.

It can be seen from the above description that by the engagement of the guide groove 324 and the adjusting member 1, it is ensured that the adjusting member 1 is directionally moved so as to enable the driving switch 2 to be accurately switched.

Further, the non-optical surface portion 322 surrounds an optical surface portion 321; a ring of annular guide grooves 324 is provided on the non-optical surface portion 322; the second opening 323 is provided in the annular guide groove 324.

It can be seen from the above description that the concentration of the light emitted from the lens 32 can be ensured by the design of the non-optical surface portion 322 around the optical surface portion 321; furthermore, the correspondingly designed annular guide groove 324 ensures that the adjusting member 1 does not interfere with the normal light extraction of the lens 32 when it is moved.

Further, the adjusting member 1 is an annular member matched with the annular guide groove 324.

It can be seen from the above description that the design of the adjusting member 1 using an annular member enables quick adjustment of the movement thereof in multiple angles and thus changes the state of the driving switch 2.

Further, the adjusting member 1 is provided with anti-skid ribs 11.

It can be seen from the above description that the anti-skid effect of the operator moving the adjusting member 1 is improved by the design of the anti-skid ribs 11.

Further, a limit hook 4 is further included, wherein a lower side of the adjusting member 1 is connected to the limit hook 4, and the limit hook 4 passes through the second opening 323 and is clamped with a lower edge of the second opening 323.

It can be seen from the above description that the limit hook 4 is clamped with the lower edge of the second opening 323, so as to limit the adjusting member 1 to prevent it from falling out.

Further, the upper side of the adjusting member 1 projects a limit edge 12 that abuts an upper edge of the second opening 323.

It can be seen from the above description that the limit edge 12 abuts the upper edge of the second opening 323, and the limit hook 4 is clamped with the lower edge, so that the adjusting member 1 can be reliably fixed on the lens 32 in the height direction of the housing 31 in a manner of being capable of being limited up and down.

Further, a side of the non-optical surface portion 322 facing the first opening is provided with a scale structure.

It can be seen from the above description that by designing the scale structure of the non-optical surface portion 322, the device inside the housing 31 can be shielded to achieve an anti-clown shielding effect.

Further, a toggle member 5 is further included, wherein the toggle member 5 is connected to the lower end of the adjusting member 1, the toggle member 5 is in transmission connection with the driving switch 2 through the second opening 323; an end portion of the toggle member 5 is provided with a toggle notch 51, and two sides of the toggle notch 51 are provided with guide inclined surfaces 52; the driving switch 2 is provided with a switch toggle handle 21, and the toggle notch 51 engages with the switch toggle handle 21.

It can be seen from the above description that the driving switch 2 is directly connected and operated by the toggle member 5 connected to the lower end of the adjusting member 1; wherein the toggle notch 51 provided on the toggle member 5 engages with the switch toggle handle 21 of the driving switch 2, and the guide inclined surface 52 provided on the toggle notch 51 can guide when the toggle member 5 moves down to engage with the driving switch 2, so as to ensure that the switch toggle handle 21 is caught in the toggle notch 51.

### Example 1

Application scenario: if the lamp 3 uses a glass housing 31 or another material housing 31 which is not suitable for opening and structure, there is no good solution on the market to place a mechanism of adjusting switch.

As shown in FIGS. 1 to 5, the novel switch toggle structure of the embodiment is provided on a lamp 3, and includes an adjusting member 1, a driving switch 2 and a toggle member 5.

As shown in FIGS. 1, 2, 3 and 5, a lamp 3 includes a housing 31, which is a glass housing 31, and a lens 32. The front end of the housing 31 is provided with a first opening, and the lens 32 is provided on the first opening; the lens 32 includes an optical surface portion 321 and a non-optical surface portion 322, wherein the optical surface portion 321 is used for transmitting light, a second opening 323 is provided on the non-optical surface portion 322, the adjusting member 1 is movably provided on the second opening 323, a lower end of the adjusting member 1 passes through the second opening 323 and is in transmission connection with driving switch 2 located inside the housing 31, specifically, the toggle member 5 is connected to the lower end of the adjusting member 1, and the toggle member 5 passes through the second opening 323 and is in transmission connection with the driving switch 2; an end portion of the toggle member 5 is provided with a toggle notch 51, and two sides of the toggle notch 51 are provided with guide inclined surfaces 52; the driving switch 2 is provided with a switch toggle handle 21, and the toggle notch 51 engages with the switch toggle handle 21.

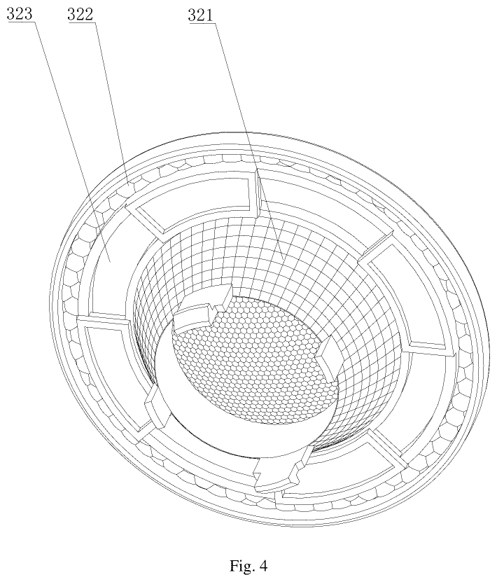

As shown in FIG. 4, a side of the non-optical surface portion 322 facing the first opening is provided with a scale structure.

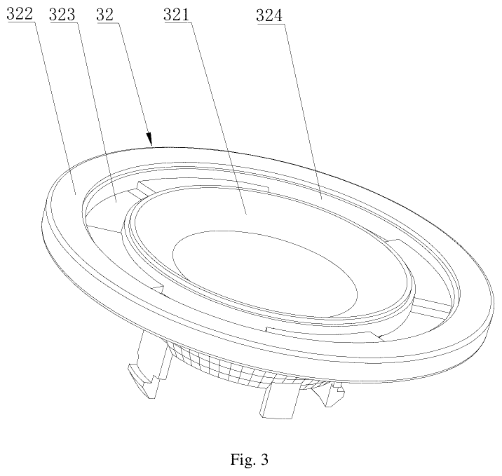

As shown in FIG. 3, the non-optical surface portion 322 is provided with a guide groove 324, and the adjusting member 1 is movably engaged with the guide groove 324. Specifically, the non-optical surface portion 322 surrounds an optical surface portion 321; a ring of annular guide grooves 324 is provided on the non-optical surface portion 322; the second opening 323 is provided in the annular guide groove 324.

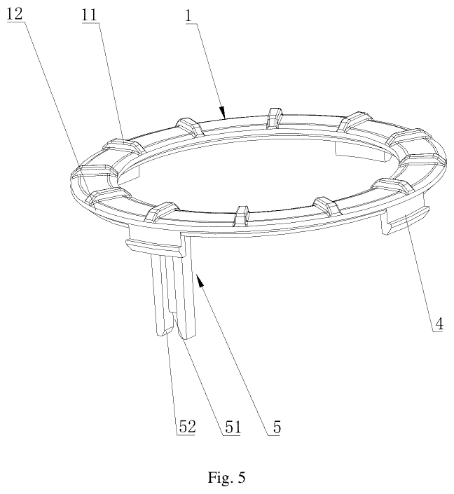

As shown in FIGS. 3 and 5, the adjusting member 1 is an annular member matched with the annular guide groove 324. The adjusting member 1 is provided with anti-skid ribs 11. The lower side of the adjusting member 1 is connected to the limit hook 4, and the limit hook 4 passes through the second opening 323 and is clamped with a lower edge of the second opening 323. The upper side of the adjusting member 1 projects a limit edge 12 that abuts an upper edge of the second opening 323.

In summary, with regard to the novel switch toggle structure provided in the present application, for some occasions where the lamp housing is not easy to be re-processed, such as the housing made of glass and ceramic, by arranging the switch adjusting structure at the lens, a second opening can be opened synchronously when the lens is processed, so that the assembled adjusting member can operate the driving switch inside the housing via the second opening; in addition, by designing the optical surface portion and the non-optical surface portion of the lens to distinguish the light transmission structure from the non-optical surface portion of the corresponding adjusting member, switching adjustment can be performed at the lens while ensuring that the lens normally emits light.

The above description is only an embodiment of the present application, and is not intended to limit the scope of the present application, and all equivalent transformation performed by using the contents of the specification and the drawings of the present application or directly or indirectly applied to the related technical fields are included in the scope of the present application.

What is claimed is:

1. A switch toggle structure, provided on a lamp, comprising an adjusting member and a driving switch; wherein the lamp comprises a housing and a lens, a front end of the housing is provided with a first opening, and the lens is provided on the opening; the lens comprises an optical surface portion and a non-optical surface portion; the optical surface portion is used for transmitting light, a second opening is provided on the non-optical surface portion, the adjusting member is movably provided on the second opening, and a lower end of the adjusting member passes through the second opening and is in transmission connection with a driving switch located inside the housing.

2. The switch toggle structure according to claim 1, wherein the non-optical surface portion is provided with a guide groove, and the adjusting member is movably engaged with the guide groove.

3. The switch toggle structure according to claim 2, wherein the non-optical surface portion surrounds the optical surface portion; a ring of annular guide grooves is provided on the non-optical surface portion; the second opening is provided in the annular guide groove.

4. The switch toggle structure according to claim 3, wherein the adjusting member is an annular member matched with the annular guide groove.

5. The switch toggle structure according to claim 1, wherein the adjusting member is provided with anti-skid ribs.

6. The switch toggle structure according to claim 1, further comprising a limit hook, wherein a lower side of the adjusting member is connected to the limit hook, the limit hook passes through the second opening and is clamped with a lower edge of the second opening.

7. The switch toggle structure according to claim 6, wherein an upper side of the adjusting member projects a limit edge that abuts an upper edge of the second opening.

8. The switch toggle structure according to claim 1, wherein a side of the non-optical surface portion facing the first opening is provided with a scale structure.

9. The switch toggle structure according to claim 1, further comprising a toggle member connected to a lower end of the adjusting member, wherein the toggle member is in transmission connection with the driving switch through the second opening; an end portion of the toggle member is provided with a toggle notch, and two sides of the toggle notch are provided with guide inclined surfaces; the driving switch is provided with a switch toggle handle, and the toggle notch is engaged with the switch toggle handle.
